(19) United States
(12) Patent Application Publication
(10) Pub. No.: US 2020/0216585 A1
(43) Pub. Date: Jul. 9, 2020

(54) METHOD FOR MANUFACTURING NON-FLUORINE WATER REPELLENT AND FABRIC

(71) Applicant: Far Eastern New Century Corporation, Taipei (TW)

(72) Inventors: Hsiang-Chin TSAI, Taoyuan City (TW); Yi-Hsuan CHANG, Taoyuan City (TW); Pang-Chin LIU, Taoyuan City (TW)

(21) Appl. No.: 16/541,184

(22) Filed: Aug. 15, 2019

(30) Foreign Application Priority Data
Jan. 4, 2019 (TW) 108100433

(51) Int. Cl. C08F 20/56; C08F 14/06; C08F 14/08; C08F 14/12; C08F 12/08; C08F 20/06; C08K 3/36; C08F 2/20; C08K 5/23

(52) U.S. Cl. CPC C08F 20/56; C08F 14/06; C08F 14/08; C08F 14/12; C08K 2201/005; C08F 20/06; C08K 3/36; C08F 2/20; C08K 5/23; C08F 12/08

(57) ABSTRACT

A method for manufacturing a fluorine-free water repellent includes: mixing a paraffin, an inorganic nanopowder and a first reactive monomer to form a first mixture, in which the first reactive monomer includes a structure represented by formula (A), formula (B) or a combination thereof, the formula (A) is

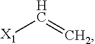

wherein X₁ is a benzene, and the formula (B) is

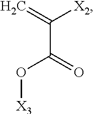

wherein X₂ is CH₃ or H and X₃ is an alkyl group having 18 or more carbon atoms; mixing an emulsifier, a cosolvent and water to form a second mixture; mixing the first mixture and the second mixture to form a pre-emulsion; and adding an initiator and a second reactive monomer into the pre-emulsion, in which the first reactive monomer and the second reactive monomer are polymerized to form a water repellent, wherein the second reactive monomer is vinylidene chloride.

### CROSS-REFERENCE TO RELATED APPLICATION

This application claims priority to Taiwan Application Serial Number 108100433, filed on Jan. 4, 2019, which is herein incorporated by reference in its entirety.

### BACKGROUND

### Field of Invention

The present invention relates to a method for manufacturing a fluorine-free water repellent. More particularly, the present invention relates to a fluorine-free water repellent able to coat a fabric.

### Description of Related Art

Perfluorinated compounds (PFCs), such as TEFLON manufactured by DuPont Corporation, have served as a water repellent in the weaving industry for a long time. However, according to related research, the perfluorinated compounds are carcinogens and may cause pregnant women to give birth to deformed babies. Besides, the perfluorinated compounds are difficult to decompose. The perfluorinated compounds remain and accumulate in the animals and plants. As a result, the perfluorinated compounds are in a long-term cycle in the natural environment. In view of the danger of the perfluorinated compounds, the European Union imposed a policy of restricting the use of perfluorooctanesulfonyl compounds on Jun. 27, 2008. In order to address the above problems, it has been proposed to apply a solution of metal nanoparticles having lotus effect to the surface of the fabric to form a water-repellent barrier layer. Nevertheless, the metal nanoparticles are manufactured by complex synthesis operations and harsh reaction conditions. In some cases, the metal nanoparticles are formed by some specific grinding and dispersion techniques. Therefore, the cost of the foregoing method is too expensive, leading to the restriction of application. Further, the fabric coated with the above-mentioned water repellent has a poor water-repellent performance after several washings, which means poor washing fastness. In view of the foregoing problems, the present invention provides a method for manufacturing a fluorine-free water repellent. The fluorine-free water repellent manufactured by the method disclosed in the present disclosure has no fluorine element, which can meet the environmental protection requirements and legal specifications, and has excellent washing fastness.

### SUMMARY

The invention provides a method for manufacturing a fluorine-free water repellent. The method includes mixing a paraffin, an inorganic nanopowder and a first reactive monomer to form a first mixture, wherein the first reactive monomer includes a structure represented by formula (A), formula (B) or a combination thereof, the formula (A) is

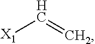

wherein X₁ is a benzene, and the formula (B) is

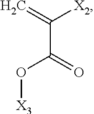

wherein X₂ is CH₃ or H and X₃ is an alkyl group having 18 or more carbon atoms; mixing an emulsifier, a cosolvent and water to form a second mixture; mixing the first mixture and the second mixture to form a pre-emulsion; and adding an initiator and a second reactive monomer into the pre-emulsion such that the first reactive monomer and the second reactive monomer are polymerized to form a water repellent, wherein the second reactive monomer is vinylidene chloride.

According to an aspect of the present invention, the inorganic nanopowder has a weight percentage of 1-20 wt %, the paraffin has a weight percentage of 20-60 wt %, the first reactive monomer and the second reactive monomer have a total weight percentage of 10-40 wt %, and the emulsifier has a weight percentage of 1-20 wt %, based on the total weight of the paraffin, the inorganic nanopowder, the second reactive monomer, the emulsifier and the first reactive monomer.

According to an aspect of the present invention, a weight ratio of the first reactive monomer to the second reactive monomer ranges from 1.5 to 2.

According to an aspect of the present invention, the first reactive monomer includes docosyl acrylate, docosyl methyl acrylate, styrene, vinyl chloride, acrylamide or a combination thereof.

According to an aspect of the present invention, the inorganic nanopowder has a particle size of 5 nm-100 nm.

According to an aspect of the present invention, the inorganic nanopowder includes SiO₂.

According to an aspect of the present invention, each of the mixing the paraffin, the inorganic nanopowder and the first reactive monomer and the mixing the first mixture and the second mixture includes using a high-pressure dispersion method.

According to an aspect of the present invention, the high-pressure dispersion method is performed at a temperature of 50-85° C. and under a pressure of 200-800 kgf/cm².

According to an aspect of the present invention, the first reactive monomer and the second reactive monomer are polymerized to form the water repellent at a temperature of 55-70° C.

According to an aspect of the present invention, the initiator comprises 2,2′-azobisisobutylphosphonium dihydrochloride, azobisisobutyronitrile or a combination thereof.

The invention also provides a fabric. The fabric includes a fluorine-free water repellent formed by the method mentioned above.

The invention also provides a fluorine-free water repellent. The fluorine-free water repellent is manufactured by the method mentioned above.

These and other features, aspects, and advantages of the present invention will become better understood with reference to the following description and appended claims.

It is to be understood that both the foregoing general description and the following detailed description are by examples, and are intended to provide further explanation of the invention as claimed.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the dimensions of the elements are not limited by the scope or value of the disclosure, but may depend on the process conditions and/or desired characteristics of the elements.

The present invention provides a method for manufacturing a fluorine-free water repellent. The fluorine-free water repellent formed by the method has good water-repellent performance in the absence of fluorine. A fabric coated with the fluorine-free water repellent provides not only excellent water-repellent performance but also superb washing fastness.

The present invention provides a method for manufacturing a fluorine-free water repellent. The method includes mixing a paraffin, an inorganic nanopowder and a first reactive monomer to form a first mixture, in which the first reactive monomer includes a structure represented by formula (A), formula (B) or a combination thereof, and the formula (A) is

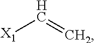

wherein X₁ is a benzene, and the formula (B) is

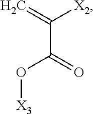

wherein X₂ is CH₃ or H and X₃ is an alkyl group having 18 or more carbon atoms; mixing an emulsifier, a cosolvent and water to form a second mixture; mixing the first mixture and the second mixture to form a pre-emulsion; and adding an initiator and a second reactive monomer into the pre-emulsion, wherein the first reactive monomer and the second reactive monomer are polymerized to form a water repellent.

In some embodiments, the inorganic nanopowder may be, for example, SiO₂. More preferably, the inorganic nanopowder has a particle size ranged from about 5 nm to about 100 nm. If the particle size of the inorganic nanopowder is greater than a certain value, such as 100 nm, the inorganic nanopowder is difficult to disperse. If the particle size of the inorganic nanopowder is less than a certain value, such as 5 nm, the fluorine-free water repellent has poor water-repellent performance. The surface roughness of the film formed by the fluorine-free water repellent may be increased by the inorganic nanopowder. Also, the inorganic nanopowder may serve as physical crosslinking points to improve the washing fastness. More preferably, the inorganic nanopowder has a particle size ranged from about 20 nm to about 80 nm, such as 50 nm.

In some embodiments, the first reactive monomer has a structure represented by formula (A), formula (B) or a combination thereof:

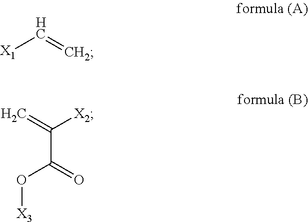

in which X₁ is a benzene, X₂ is CH₃ or H, and X₃ is an alkyl group having 18 or more carbon atoms. It is noted that a combination of the formula (A) and formula (B) herein indicates that the first reactive monomer has both the structures represented by the formula (A) and the formula (B). In some embodiments, the foregoing first reactive monomer includes docosyl acrylate, docosyl methyl acrylate, styrene, vinyl chloride, acrylamide or a combination thereof.

In some embodiments, the second reactive monomer includes glycidyl methacrylate, 2-hydroxyethyl methacrylate, 1,1-dichloroethene, ethyl acrylate, 2-hydroxypropyl methacrylate, 3-chloro-2-hydroxypropyl methacrylate or a combination thereof. More preferably, the second reactive monomer is 1,1-dichloroethene.

In detail, a weight ratio of the first reactive monomer to the second reactive monomer ranges from about 1.5 to about 2, such as 1.75.

In some embodiments, the paraffin has a melting point ranged from about 55° C. to about 85° C. The performance of the fluorine-free water repellent becomes better as the melting point of the paraffin is greater. However, the paraffin having a melting point greater than 85° C. may increase the difficulties of emulsification and production.

In some embodiments, the emulsifier may be ethoxylated quaternary ammonium compounds, for example, such as Ethoquad HT/25 produced by AkzoNobel Corporation.

In some embodiments, the initiator includes 2,2′-azobisisobutylphosphonium dihydrochloride, azobisisobutyronitrile or a combination thereof.

In some embodiments, the inorganic nanopowder has a weight percentage of 1-20 wt %, the paraffin has a weight percentage of 20-60 wt %, the first reactive monomer and the second reactive monomer have a total weight percentage of 10-40 wt %, and the emulsifier has a weight percentage of 1-20 wt %, based on a total weight of the inorganic nanopowder, the paraffin, the first reactive monomer, the second reactive monomer and the emulsifier. If the amount of the inorganic nanopowder is excessive or less, such as greater than 20 wt % or less than 1 wt %, the fluorine-free water repellent has poor performance. If the amount of the paraffin is greater than a certain value, such as 60 wt %, the processing becomes more difficult. If the amount of the paraffin is less than a certain value, such as 20 wt %, the fluorine-free water repellent has poor performance. If the amount of the emulsifier is greater than a certain value, such as 20 wt %, the contents of other components of the fluorine-free water repellent become less, which affects the water-repellent performance of the fluorine-free water repellent. If the amount of the emulsifier is less than a certain value, such as 1 wt %, the efficacy of the emulsifier serving as a surfactant is undesirably reduced.

Hereinafter, a method for manufacturing a fluorine-free water repellent of the present invention is described. First, a paraffin, an inorganic nanopowder and a first reactive monomer are mixed to form a first mixture, in which the first reactive monomer may be at least one of the first reactive monomers mentioned above.

An emulsifier, a cosolvent and water are mixed in another container to form a second mixture. In some embodiments, forming the first mixture and the second mixture may include using a high-pressure dispersion method, in which the high-pressure dispersion method is performed at a temperature of 50-85° C. and under a pressure of 200-800 kgf/cm².

In some embodiments, the cosolvent may include 1,2-propanediol, dipropylene glycol, tripropylene glycol, tetrapropylene glycol, acetone, methyl ethyl ketone, propylene glycol methyl ether, di(propylene glycol) methyl ether or a combination thereof. The amounts of the cosolvent and the water are not limited. More preferably, the amounts of the cosolvent and the water may be greater than the weight of the first mixture.

Thereafter, the first mixture and the second mixture are mixed to form a pre-emulsion. The foregoing high-pressure dispersion method may be used in the operation of forming the pre-emulsion, in which the operation is performed at a temperature of 50-85° C. and under a pressure of 200-800 kgf/cm².

A second reactive monomer and an initiator are added into the pre-emulsion after the pre-emulsion is formed. The second reactive monomer may be vinylidene chloride.

The first monomer and the second monomer are polymerized after adding the second reactive monomer and the initiator into the pre-emulsion to form a fluorine-free water repellent. In some embodiments, the polymerization is performed at a temperature of 55-70° C. In some embodiments, the polymerization is performed in a reflux apparatus under a nitrogen atmosphere. In detail, the reactive monomer quickly captures the free radicals produced by the initiator. For example, the double bond of the vinylidene chloride and the double of the other first reactive monomers are subjected to a polymerization reaction.

The present invention also provides a fabric coated with the fluorine-free water repellent herein. Therefore, the fabric includes the fluorine-free water repellent manufactured by the above-mentioned method. The coating process is not limited, and any suitable coating processes may be adopted, such as direct coating, transfer coating and calendered coating.

Some embodiments are provided hereinafter to make the present disclosure more clear.

### Embodiment 1

Cerium oxide nanopowder (SiO2) (5 g), paraffin (having a melting range of 68° C.-74° C.) (105 g), docosyl acrylate (17.5 g), docosyl methyl acrylate (17.5 g) and styrene (10 g) were mixed at a temperature of 85° C. and under a pressure of 250 bar to form a first mixture. Ethoquad HT/25 (12 g), dipropylene glycol (30 g) and water (450 g) were mixed in another container at a temperature of 85° C. and under a pressure of 250 bar to form a second mixture. Thereafter, vinylidene chloride (20 g) and an initiator solution were added after the first mixture and the second mixture were mixed, in which the initiator solution includes 2,2′-azobisisobutylphosphonium dihydrochloride (V50) (2.5 g) and water (15 g). Then, the formed mixture was refluxed under a nitrogen atmosphere at a temperature of 56° C. for 8 hours to form a fluorine-free water repellent.

### Embodiments 2

Cerium oxide nanopowder (SiO2) (10 g), paraffin (having a melting range of 68° C.-74° C.) (105 g), docosyl acrylate (17.5 g), docosyl methyl acrylate (17.5 g) and styrene (10 g) were mixed at a temperature of 85° C. and under a pressure of 250 bar to form a first mixture. Ethoquad HT/25 (12 g), dipropylene glycol (30 g) and water (450 g) were mixed in another container at a temperature of 85° C. and under a pressure of 250 bar to form a second mixture. Thereafter, vinylidene chloride (20 g) and an initiator solution were added after the first mixture and the second mixture were mixed, in which the initiator solution includes 2,2′-azobisisobutylphosphonium dihydrochloride (V50) (2.5 g) and water (15 g). Then, the formed mixture was refluxed under a nitrogen atmosphere at a temperature of 56° C. for 8 hours to form a fluorine-free water repellent.

### Comparative Example 1 (without Inorganic Nanopowder)

Docosyl acrylate (17.5 g), docosyl methyl acrylate (17.5 g), styrene (10 g), Ethoquad HT/25 (12 g), dipropylene glycol (30 g) and water (450 g) were mixed at a temperature of 85° C. and under a pressure of 250 bar to form a first mixture. Paraffin (having a melting range of 68° C.−74° C.) (105 g) was melted in another container. Thereafter, vinylidene chloride (20 g) and an initiator solution were added after the first mixture and the melted paraffin were mixed, in which the initiator solution includes 2,2′-azobisisobutylphosphonium dihydrochloride (V50) (2.5 g) and water (15 g). Then, the formed mixture was refluxed under a nitrogen atmosphere at a temperature of 56° C. for 8 hours to form a fluorine-free water repellent.

### Comparative Example 2 (without Paraffin)

Cerium oxide nanopowder (SiO2) (5 g), docosyl acrylate (17.5 g), docosyl methyl acrylate (17.5 g) and styrene (10 g) were mixed at a temperature of 85° C. and under a pressure of 250 bar to form a first mixture. Ethoquad HT/25 (12 g), dipropylene glycol (30 g) and water (450 g) were mixed in another container at a temperature of 85° C. and under a pressure of 250 bar to form a second mixture. Thereafter, vinylidene chloride (20 g) and an initiator solution were added after the first mixture and the second mixture were mixed, in which the initiator solution includes 2,2′-azobisisobutylphosphonium dihydrochloride (V50) (2.5 g) and water (15 g). Then, the formed mixture was refluxed under a nitrogen atmosphere at a temperature of 56° C. for 8 hours to form a fluorine-free water repellent.

### Comparative Example 3 (without Inorganic Nanopowder and Paraffin)

Docosyl acrylate (17.5 g), docosyl methyl acrylate (17.5 g) and styrene (10 g) were mixed at a temperature of 85° C. and under a pressure of 250 bar to form a first mixture. Ethoquad HT/25 (12 g), dipropylene glycol (30 g) and water (450 g) were mixed in another container at a temperature of 85° C. and under a pressure of 250 bar to form a second mixture. Thereafter, vinylidene chloride (20 g) and an initiator solution were added after the first mixture and the second mixture were mixed, in which the initiator solution includes 2,2′-azobisisobutylphosphonium dihydrochloride (V50) (2.5 g) and water (15 g). Then, the formed mixture was refluxed under a nitrogen atmosphere at a temperature of 56° C. for 8 hours to form a fluorine-free water repellent.

### Comparative Example 4 (Only Paraffin)

Paraffin (having a melting range of 68° C.−74° C.) (105 g) was melted. Ethoquad HT/25 (12 g), dipropylene glycol (30 g) and water (450 g) were mixed in another container at a temperature of 85° C. and under a pressure of 250 bar to form a mixture. The melted paraffin was added into the mixture and then mixed at a temperature of 85° C. and under a pressure of 250 bar to form a fluorine-free water repellent.

The fluorine-free water repellents prepared in the above Embodiments 1-2 and Comparative Examples 1-4 were diluted with water in a ratio of 100 g/liter. A polyester woven fabric is impregnated with the diluted fluorine-free water repellent by a dip-and-roll method. Thereafter, the polyester woven fabric was dried at a temperature of 120° C., and further heat-treated at a temperature of 160° C. for two minutes and then subjected to the following test.

Table 1 is the experimental data of Embodiments 1-2 and Comparative Examples 1-4, in which the test for water-repellent performance is based on the AATCC 22 standard, and the test for washing fastness is based on the ISO 6330 standard. The storage stability test is to determine whether there is stratification and/or solid precipitation after storing the fluorine-free water repellent for three months at room temperature. If there is no stratification and no solid precipitation, it means “stable”. To the contrary, it is “unstable”.

TABLE 1

| | initial | water-repellent | water-repellent | |
|---|---|---|---|---|
| | water- | performance | performance | |
| | repellent | after washing | after washing | storage |
| | performance | 10 times | 20 times | stability |
| Embodiment 1 | 90+ | 100 | 100 | stable |
| Embodiment 2 | 100 | 100 | 100 | stable |
| Comparative | 80 | 80 | 70 | stable |
| Example 1 | | | | |
| Comparative | 80 | 90 | 70 | stable |
| Example 2 | | | | |
| Comparative | 70 | 70 | 50 | stable |
| Example 3 | | | | |
| Comparative | 60 | 60 | 50 | stable |
| Example 4 | | | | |

From the results of Table 1, Embodiments 1-2 were superior to Comparative Examples 1-4 in the initial water-repellent performance. After multiple washings, Embodiments 1-2 still maintained excellent water-repellent performance. However, the water-repellent performance dramatically declined after multiple washings in Comparative Examples 1-4. In summary, the fluorine-free water repellent formed by the method provided herein may provide good water-repellent performance and washing fastness. Even after multiple washings, the fluorine-free water repellent still has superb water-repellent performance similar to the initial state.

The invention provides a fluorine-free water repellent and a manufacturing method thereof. The fluorine-free water repellent may significantly increase the water-repellent performance of the fabric, and also have good washing fastness. After multiple washings, the fluorine-free water repellent still has excellent water-repellent performance. Besides, the fluorine-free water repellent provided herein has good storage stability. In other words, the fluorine-free water repellent may be stored for a long time without stratification or forming solid precipitates.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for manufacturing a fluorine-free water repellent, comprising:
mixing a paraffin, an inorganic nanopowder and a first reactive monomer to form a first mixture, wherein the first reactive monomer comprises a structure represented by formula (A), formula (B) or a combination thereof, the formula (A) is 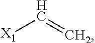
wherein X₁ is a benzene, and the formula (B) is 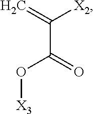
wherein X₂ is CH₃ or H and X₃ is an alkyl group having 18 or more carbon atoms;
mixing an emulsifier, a cosolvent and water to form a second mixture;
mixing the first mixture and the second mixture to form a pre-emulsion; and
adding an initiator and a second reactive monomer into the pre-emulsion such that the first reactive monomer and the second reactive monomer are polymerized to form a water repellent, wherein the second reactive monomer is vinylidene chloride.

2. The method of claim 1, wherein the inorganic nanopowder has a weight percentage of 1-20 wt %, the paraffin has a weight percentage of 20-60 wt %, the first reactive monomer and the second reactive monomer have a total weight percentage of 10-40 wt %, and the emulsifier has a weight percentage of 1-20 wt %, based on the total weight of the paraffin, the inorganic nanopowder, the second reactive monomer, the emulsifier and the first reactive monomer.

3. The method of claim 2, wherein a weight ratio of the first reactive monomer to the second reactive monomer ranges from 1.5 to 2.

4. The method of claim 1, wherein the first reactive monomer comprises docosyl acrylate, docosyl methyl acrylate, styrene, vinyl chloride, acrylamide or a combination thereof.

5. The method of claim 1, wherein the inorganic nanopowder has a particle size of 5 nm-100 nm.

6. The method of claim 1, wherein the inorganic nanopowder comprises SiO₂.

7. The method of claim 1, wherein each of the mixing the paraffin, the inorganic nanopowder and the first reactive monomer and the mixing the first mixture and the second mixture includes using a high-pressure dispersion method.

8. The method of claim 7, wherein the high-pressure dispersion method is performed at a temperature of 50-85° C. and under a pressure of 200-800 kgf/cm².

9. The method of claim 1, wherein the first reactive monomer and the second reactive monomer are polymerized to form the water repellent at a temperature of 55-70° C.

10. The method of claim 1, wherein the initiator comprises 2,2′-azobisisobutylphosphonium dihydrochloride, azobisisobutyronitrile or a combination thereof.

11. A fabric comprising a fluorine-free water repellent formed by the method of claim 1.

12. A fluorine-free water repellent formed by the method of claim 1.
